(19) United States
(12) Patent Application Publication
(10) Pub. No.: US 2013/0294885 A1
(43) Pub. Date: Nov. 7, 2013

(54) AUGMENTED FLUID TURBINE WITH RETRACTABLE WALL PANELS AND AERODYNAMIC DEFLECTORS

(71) Applicant: Frederic Churchill, Monteral (CA)

(72) Inventor: Frederic Churchill, Monteral (CA)

(73) Assignee: ORGANOWORLD INC., Montreal (CA)

(21) Appl. No.: 13/932,951

(22) Filed: Jul. 1, 2013

Related U.S. Application Data
(63) Continuation of application No. PCT/CA2011/001408, filed on Dec. 29, 2011.
(60) Provisional application No. 61/427,980, filed on Dec. 29, 2010.

(51) Int. Cl. F03D 1/04; F03D 11/00; F03B 3/18

(52) U.S. Cl. CPC F03D 1/04; F03B 3/183; F03D 11/0091
USPC 415/4.3; 415/48

(57) ABSTRACT

A fluid turbine apparatus for use with a turbine comprising a convergent section, a fluid turbine section adjacent to an outlet of the convergent section, and a divergent section adjacent to the fluid turbine section. The fluid enters through the convergent section and exits through the divergent section. The convergent and divergent sections are constructed using a modular grid-like structure supporting retractable wall panels. The internal vacuum created by the diffuser and the wind shear stresses on the convergent and divergent sections can be limited. Configurations of the convergent and divergent sections can be adjusted to suit prevailing wind velocities. Barriers of rotating deflectors are used to increase the effective area of the convergent and divergent sections during low wind conditions. Horizontally mounted aerodynamic deflectors may be used to decrease wind shear and drag on the divergent section, the turbine section, and on side walls of the convergent section.

### FIELD OF THE INVENTION

The present invention generally relates to wind turbines and more specifically relates to augmented wind turbines that use large convergent and divergent sections, whose vertical walls, and to a lesser extent horizontal walls, can generate significant wind shear forces and drag in strong winds.

### BACKGROUND OF THE INVENTION

In general, the forces developed in augmented wind turbines will be proportional to the total wall area. Larger wall areas generally mean larger wall forces against the supporting structural elements and overall increased wind shear and drag effects. In high wind conditions or in applications involving large surface areas, these forces can lead to heavy damage to the walls, to the destruction of the convergent and divergent sections, to the danger of falling and flying objects for any local population and to a capsizing of the turbine tower. The forces of vacuum generated in the convergent and divergent sections of an augmented turbine will increase with increasing wind speed and the wall panels must be progressively retracted to prevent a collapse of the walls and structure of the convergent and the divergent. It is crucial that the panels of the side walls can be deployed and retracted progressively as the energy of the wind increases and decreases. This action should be computer controlled with alarms to the operator for abnormal operating conditions.

It is established that a convergent device located ahead of the flow turbine and a divergent device located downstream of the flow turbine will increase the speed or kinetic energy of the flow streamline in the ducted channel of the turbine located between the convergent and divergent. This increase in kinetic energy is known as the Venturi effect.

Diffuser Assisted Wind Turbines (DAWT) are a class of wind turbine that uses one-piece walled structures to accelerate wind before it enters the wind-generating element. It is well established that a DAWT will operate at higher wind speeds through the rotor blades as a result of the Venturi effect created by the diffuser. The concept of these diffuser structures and their effects has been around for decades but has not gained wide acceptance in the marketplace.

The principal reason that the DAWT has not been a commercial success comes from the fact that the large size of the diffuser structure has limited its applicability. The diffuser is most often conical in shape and is a one piece design. It has become more economical to simply increase the swept area of the rotor of a non augmented turbine. The limitation in the size of the diffuser is an economic issue but also a design issue. Large diffusers in very high winds develop tremendous forces and the structure necessary to resist these forces is both complicated and expensive.

The structural requirement in terms of resisting overturning and bending in extreme wind events which all wind turbines must be designed for by an ISO standard. The traditional DAWT turbine structure has poor drag characteristics. That combined with higher solidity of the rotor leads to substantially greater structural costs than a three bladed turbine in the support structure, the yaw bearing, and the foundation.

For these reasons, traditional DAWTs have not been a solution to improving wind energy production at the utility-scale. The power increases thus far have proved insufficient to offset the structural costs. In small wind applications where structural issues are lessened, they may be better than standard three bladed wind turbines if it can be definitively shown that they can improve output for the same cost.

To date, there exists no commercial designs for a utility-scale augmented turbine using a convergent and a divergent section connected to a ducted turbine section. The convergent section, although smaller in size than the divergent section, can still be a very large structure and resisting high wind conditions thus remains a design challenge. Convergent and divergent sections may have exterior walls that are straight and generate a rectilinear shape, or the walls may be circular and generate a conical shape or a mixture of straight and curved walls generating a more complex shape.

The normal wind speeds during turbine operations will vary from 4 to 12 m/s and the corresponding densities of the wind energy will increase 27 times from 39.3 to 1062.7 W/m². A structural design could be provided for a convergent and divergent section operating strictly in low wind conditions, but this would significantly reduce the amount of energy produced by the turbine which would increase significantly the operating costs.

As the wind energy is proportional to the wind velocity cubed, tripling the wind velocity from 4 to 12 m/s implies the energy has increased by a factor of 27 (3×3×3=27). If the units were to be designed to operate as one size for all operating conditions, the required weight and size of the structural members and strength of the panels would make the turbine apparatus economically unfeasible. There is no doubt that the same size of convergent and divergent sections that is designed for a wind of 4 m/s would be destroyed or be unfeasible at a velocity of 12 m/s.

The variation in wind energy has two effects on the walls of the convergent and divergent sections. Firstly, the drag caused by the wind flowing along the walls of the structure are proportional to the wind velocity cubed and secondly, the levels of vacuum generated in the convergent and divergent sections also increase with the wind velocity cubed.

In a prior PCT patent application by the applicant (Turbine Apparatus, Application No. PCT/CA2009/000797), the configurations of the convergent and divergent to obtain optimum increase in flow velocity were established. The configurations cited were most applicable when air was the gas being used to power the rotor. One knows that by the phenomenon of dynamic similitude that the same results can be obtained for flow through a convergent divergent device if the Reynolds numbers are similar.

In order to build large augmented wind turbines, the design problem associated with high wind shear and vacuum must be addressed and the solution must be economical and not interfere with the necessity of having a very smooth inner wall surface. Thus, there is a need for an innovative solution for resolving the high wind shear and drag and vacuum problems associated with large convergent and divergent of different shapes employed to increase the wind speed through an augmented wind turbine.

### SUMMARY OF THE INVENTION

An object of the present invention is to provide an apparatus that addresses at least one of the above mentioned needs.

The principal design, advantages of the apparatus are the use of very large convergent and divergent sections to maximise the kinetic energy of the air as it passes through the turbine rotor and to build the walls as retractable panels such that as the wind speed increases, the size of the convergent and divergent can be progressively decreased. These two aforementioned elements adjust the size of the convergent and divergent sections to be appropriate for the prevailing wind speed, that in turn reduces the cost/kWh of the turbine installation and will produce a more competitive source of energy.

### OBJECTIVES OF THE INVENTION

A first objective of the present invention is to provide an apparatus to generate electricity efficiently by a fluid turbine that is driven directly by air flow and the velocity of the fluid flow is maximised by the application of a convergent and a divergent section with an optimum size configuration.

A second objective of the present invention is to maximise the energy derived by building very large convergent and divergent sections using a modular construction rather than a one-piece construction that permits the progressive retraction of the appropriate wall areas of the convergent and divergent as the wind velocity increases.

A third objective is to provide a system for optimising the overall energy production such that at low wind speeds the areas of the convergent and divergent are in their largest overall shape and at high wind conditions the convergent and divergent assume their smallest shape. The system is designed such that, as the walls are progressively retracted, the wind velocity through the rotor blades and the vacuum created within the turbine remains relatively constant.

A fourth objective is to provide a system that produces lower cost electricity from the energy of wind and this requires the ability to use very large convergent and divergent structures that are designed to reduce the increasing drag forces generated on the overall turbine apparatus and tower structure as the wind velocity increases and to employ wall panels designed to retain their shape as the level of vacuum increases.

According to the present invention, there is provided a fluid turbine apparatus for use with at least one fluid turbine, said fluid turbine apparatus comprising:
a convergent section, said convergent section comprising an inlet and an outlet, said inlet having a area higher than said outlet, said convergent section having a first ratio being the inlet area over the outlet area and a modular grid-like structure supporting a plurality of convergent section retractable wall panels;
a fluid turbine section adjacent to said outlet of said convergent section, said fluid turbine section comprising said at least one fluid turbine and having a central axis;
a divergent section adjacent to said fluid turbine section, said divergent section comprising an inlet and an outlet, said inlet having an area lower than said outlet, said divergent section having a second ratio being the outlet area over the inlet area and a modular grid-like structure supporting a plurality of divergent section retractable wall panels; and
a controller for selectively deploying and retracting the convergent and divergent section retractable wall panels,
   wherein the fluid enters through said convergent section and exits through said divergent section.

Preferably, the aforesaid and other objectives of the present invention are realised by providing a convergent and divergent structure with modular retractable wall sections to create an augmented wind turbine that increases the velocity contacting the fluid turbine rotor, the turbine apparatus comprising:
a wind tower structure to support the weight of the turbine apparatus and the vertical and horizontal forces, in the form of weight, wind shear and drag, exerted by the wind flowing around said apparatus;
a convergent section with retractable walls at each turbine apparatus, the convergent comprising an inlet and an outlet, the inlet having an area higher than said outlet, the convergent section having a first ratio being the inlet area on the outlet area,
a fluid turbine section at each turbine apparatus adjacent to the outlet of the convergent section, the fluid turbine section comprising the fluid turbine,
a divergent section with retractable walls at each turbine apparatus adjacent to the fluid turbine section, the divergent section comprising an inlet and an outlet, the inlet having an area lower than the outlet, the divergent section having a second ratio being the outlet area on the inlet area,
a grid-like structure to support the panels that constitute the walls of the convergent and divergent sections,
a set of flexible panels that can be retracted and deployed and are equipped with stiffening bars oriented in the direction of the retraction mechanism in order to hold a flat surface when operating under vacuum conditions created by the divergent section.
a computerised control system that monitors the prevailing wind speed and progressively deploys or retracts specific panels of the convergent and divergent to maximise the energy produced and minimise the risk of a structural failure,
an alarm system that advises the operator of any abnormality between the actual configuration of the convergent and divergent and its programmed configuration for the particular wind speed,
a retractable set of deflectors that are positioned around the periphery of the outlet of the divergent and the periphery of the inlet of the convergent
   wherein fluid enters through the convergent section and exits through the divergent section and wherein the fluid turbine apparatus has a third ratio being the outlet area of the divergent section on the inlet area of the convergent section.

Preferably, the combination of the convergent section, the fluid turbine section and the divergent section must be such that a Venturi effect is created. The Venturi effect derives from a combination of Bernoulli's principle and the equation of continuity. The convergent section serves to pressurize the inlet to the fluid turbine section whereas the divergent section serves to create a vacuum at the exit of the fluid turbine section.

Preferably, a plurality of structural members that connect in series and extend out from the fluid turbine section along the centerline of said fluid turbine support the retractable panels/walls of the convergent and divergent sections,

Preferably, a grouping of said retractable walls at specific distances relative to the configuration of the turbine sections is provided such that the above mentioned first second and third ratios are adjusted to hold the wind velocity relatively constant through the fluid turbine section as the wind velocity increases and decreases. This grouping of the retractable walls also adjusts and limits the drag and wind shear forces generated at different wind speeds by the turbine apparatus against the wind tower structure.

Preferably, the convergent section of the fluid turbine apparatus is defined as a section having an inlet which is larger than its outlet. The outlet of the convergent section is in contact with the inlet of the fluid turbine section. The length and configuration of the convergent section employing retractable walls are adjusted to minimise drag produced at high wind speeds and to make uniform the velocity profile at the convergent outlet so that a more even air flow is created at the inlet of the fluid section.

Preferably, the divergent section is defined as a section having an inlet which is smaller than its outlet. The inlet of the divergent section is in contact with the outlet of the fluid turbine section. The length and configuration of the divergent section employing retractable walls are adjusted to minimise drag produced at high wind speeds and to make uniform the velocity profile at the divergent inlet so that a more even vacuum is created at the inlet of the fluid section.

Preferably, it has been determined that the structural members that extend out from the turbine section will be arranged to provide a minimum of 1 and maximum of 8 vertical and horizontal modules and that each module shall support the retractable and fixed wall sections that establish its outside walls. The percentage of the surface area of the retractable wall surface to the fixed wall surface of each module may vary.

Preferably, the shape of the cross-section of the different convergent and divergent sections may vary (circular, rectangular, annular, etc.). However, the preferred shape of the cross section of the large convergent and divergent sections are rectilinear. Smaller convergent and divergent sections may be circular and preferably be similar to the shape of the cross section of the outlet of the fluid turbine section to keep a laminar flow in the divergent section.

Preferably, it is to be noted that the fluid turbine section may have a shape that differs from the divergent section and/or the convergent section. In this case a transition section is installed between the fluid turbine section and the divergent section and/or the convergent section to preserve a laminar flow.

In a further embodiment, the retractable walls may be made of fabric material and stiffeners or they may be made of hinged metallic sections. In both cases, a drive mechanism is employed to deploy and retract each of the retractable wall panels. The retractable wall panels are actuated in groupings that are determined in function of the prevailing wind speed. As the wind speed increases panels are progressively retracted to limit the vacuum within the convergent and divergent structures, to limit the drag generated by the wind against the structures and to ensure that the maximum feasible amount of energy is being produced by the fluid turbine without risk of structural damage.

### BRIEF DESCRIPTION OF THE DRAWINGS

These and other objects and advantages of the invention will become apparent upon reading the detailed description and upon referring to the drawings in which

FIG. 1 is a schematic cross-section view of a possible rectilinear shaped convergent-divergent, according to a preferred embodiment of the present invention, with its walls in the retracted position.

FIG. 2 is a schematic cross-section view of the possible rectilinear shaped convergent-divergent shown in FIG. 1, with its walls in the deployed position.

FIG. 3 is a schematic cross-section view of a modular panel section of a possible rectilinear shaped panel, according to a preferred embodiment of the present invention.

FIGS. 4a and 4b are schematic side and cross section views respectively of a modular flexible panel with stiffening bars and its retraction/deployment mechanism, according to a preferred embodiment of the present invention.

FIGS. 5a and 5b are schematic side and cross section views respectively of a circular divergent section and circular fluid turbine section with horizontally mounted aerodynamic deflectors, according to a preferred embodiment of the present invention.

FIGS. 6a and 6b are schematic side and cross section views respectively of a convergent section with horizontally mounted aerodynamic deflectors, according to a preferred embodiment of the present invention

### LEGEND FOR ABOVE DRAWINGS

1: turbine tower structure

2: convergent section

3: fluid turbine section

4: divergent section

5: structural member

6: deployable and retractable wall panel

7: flexible panel stiffening bars

8: panel deployment and retraction mechanism

9: wind turbine apparatus

12: rotating deflectors

13: horizontally-mounted aerodynamic deflector

While the invention will be described in conjunction with an example embodiment it will be understood that it is not intended to limit the scope of the invention to such embodiment, On the contrary, it is intended to cover all alternatives modifications and equivalents as may be included as defined by the appended claims.

### DESCRIPTION OF PREFERRED EMBODIMENTS

In the following description, similar features in the drawings have been given similar reference numerals and in order to weight down the figures some elements are not referred to in some figures if they were already identified on a previous figure.

A novel fluid turbine apparatus using convergent and divergent sections and composed of retractable wall panels will be described hereinafter. Although the invention is described in terms of specific illustrative embodiments(s) it is to be understood that the embodiment(s) described herein are by way of example only and that the scope of the invention is not intended to be limited thereby.

A large variation in the wind energy and forces on the turbine apparatus in general, and the structure of the convergent and divergent sections in particular, means that, to operate efficiently, the design of the convergent and divergent sections must allow for a progressive decrease in the area of the convergent and divergent section walls.

This requires a modular grid-like structure to support the panels of the convergent and divergent sections. Simply stated, as the wind velocity increases, selected panels are retracted and, as the wind velocity decreases, selected panels are deployed.

A controller, such as a computer control system then selectively deploys or retracts individual panels in order to control the drag and vacuum forces on the walls and to produce the maximum amount of energy at all wind speeds. This flexibility in matching wind velocity to the size of the convergent and divergent sections is absolutely necessary to assure the economic viability of a DAWT turbine operating with a convergent and divergent section.

In the event that the controller detects an abnormality in the deployment of the wall panels, an alarm would be sounded in order that the operator take immediate action before the convergent and divergent structures or the turbine apparatus incurs structural damage.

When a convergent section is used with a divergent section, the operation of the convergent section changes in that it is now always operating under vacuum; as is the divergent section. The flow conditions of the air stream as it proceeds through the convergent and divergent sections are crucial to their efficiency. The biggest problem is boundary layer separation. Once the air travelling along the face of the side walls loses too much energy with respect to the main body of air flow, the boundary layer flow stream breaks away from the wall and begins to swirl. The overall efficiency of the convergent or divergent sections begins to decrease. This requires that designs incorporate features to assure that interior wall panels remain flat and very smooth and that the members of the structure of the convergent and divergent create minimal obstruction to air flow.

Accordingly, if the panels are made of flexible material, they will include reinforcing bars that span the panel between structural members to keep them straight (flat) under the conditions of vacuum created by the divergent section. If the panel is retracted by winding itself around a horizontal axis, the bars would be positioned horizontally in the panels. If the panels are retracted by winding themselves around a vertical axis, they would be placed vertically in the panels.

If the divergent section, or part of the divergent section, were to be of a circular configuration rather than rectilinear, the challenge of the wind shear could be addressed differently. The principal challenge of wind shear and drag occurs if the wind were to strike the divergent section at right angles to the central axis of the turbine ducted tunnel. This is a completely abnormal situation as the turbine is designed to follow the wind and would be a worst case situation for wind shear and drag.

An alternative solution for wind shear and drag would be to install aerodynamic deflectors on both sides of the circular diffuser along its horizontal centre line. The deflectors would decrease the shear forces on the windward side and decrease the drag on the leeward side of the diffuser.

A convergent section designed using Borger optimisation theory (as illustrated in drawings) will have an inlet surface area much smaller than the surface area of the outlet of the divergent. Accordingly, it will be smaller in dimension than the divergent section, while the height of the side walls will be much shorter than the width of its top and bottom. Given the smaller dimensions of the side walls, it may be possible to mount the same type of aerodynamic deflectors on both side walls of the convergent as suggested above for the circular diffuser. It is understood that horizontal wind forces are always much more severe than vertical wind forces.

In order to limit the vacuum generated by the convergent and divergent sections, retractable panels would be installed in the top and bottom sections of the convergent section. By retracting and deploying these panels, the efficiency of the convergent section will increase and decrease and this in turn will modify the efficiency of the divergent section. It will be possible to limit the vacuum generated by the divergent section by simply decreasing the efficiency of the convergent section.

As discussed above, the retraction and deployment of the panels in the convergent section would preferably be under computer control and would be programmed to maximise energy production and to limit the vacuum generated. The threat of wind shear and wind drag, however, could be addressed by the use of deflectors mounted on the horizontal walls of the convergent section and of a circular divergent section and of a circular fluid turbine section.

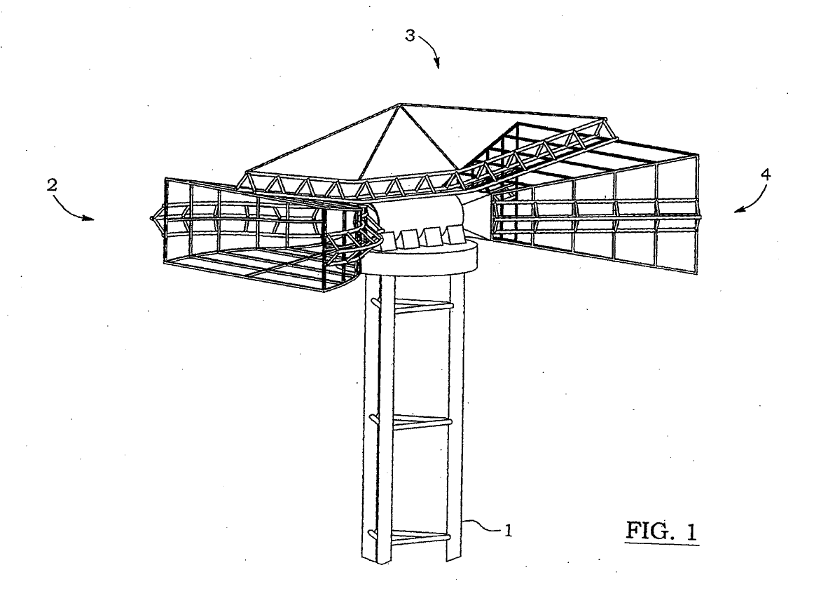

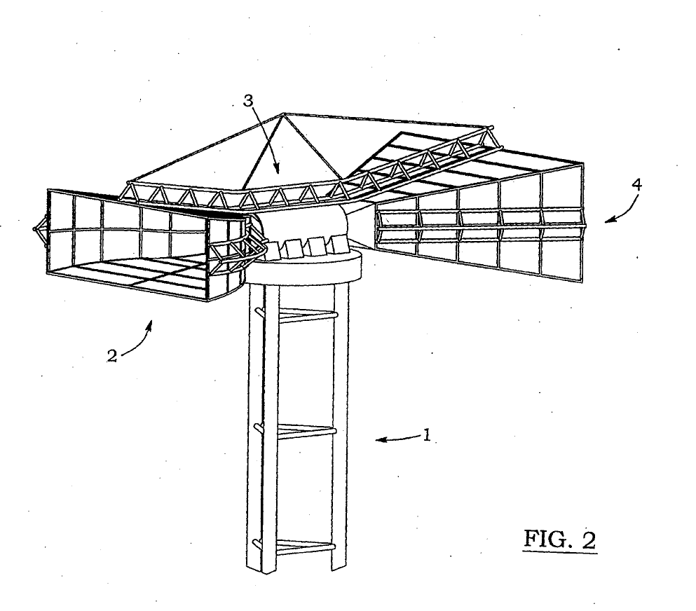

FIGS. 1, 2, and 3 show the principal configurations of convergent and divergent sections that may be considered for an augmented turbine apparatus and include rectilinear, conical and annular configurations. In the preferred embodiment, the convergent section (2) and divergent section (4) are rectilinear and surround a cylindrical turbine section (3). However conical and annular convergent and divergent sections can also be used.

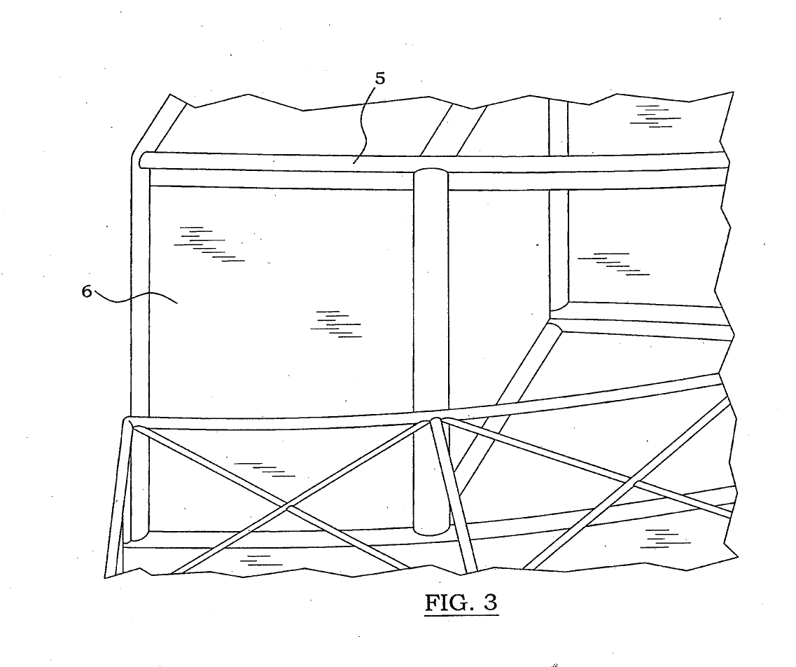

As shown in FIG. 3, the modular and retractable wall panels (6) are independently controlled. As the wind velocity begins to increase and the drag on the wind turbine apparatus increases, the retractable wall panels in the modular sections of the convergent and divergent sections farthest from the fluid turbine section are retracted. If the wind shear and drag and internal vacuum continue to increase, the retractable panels (6) at the next farthest section from the fluid turbine section are retracted. This progression will continue if the wind velocity continues to increase and the result is a shortening of the length of the convergent and divergent sections with a reduction of the inlet area of the convergent section and the outlet area of the divergent section. The order of the progression is a function of the wind velocity and the capacity of the turbine electrical generator.

Similarly if the wind velocity begins to fall, the next farthest section of the convergent and the divergent sections will be deployed. This will lengthen the convergent and divergent sections and will increase the inlet area of the convergent section and the outlet area of the divergent section. The intent is to uniform the rate of power production and thereby optimise the load on the electrical system and to limit the horizontal forces on the structural members of the convergent and divergent and on the turbine tower structure.

In a further non illustrated preferred embodiment of the convergent-divergent, the farthest end sections of the convergent and divergent can advance and retract. This permits a lengthening of the convergent and divergent.

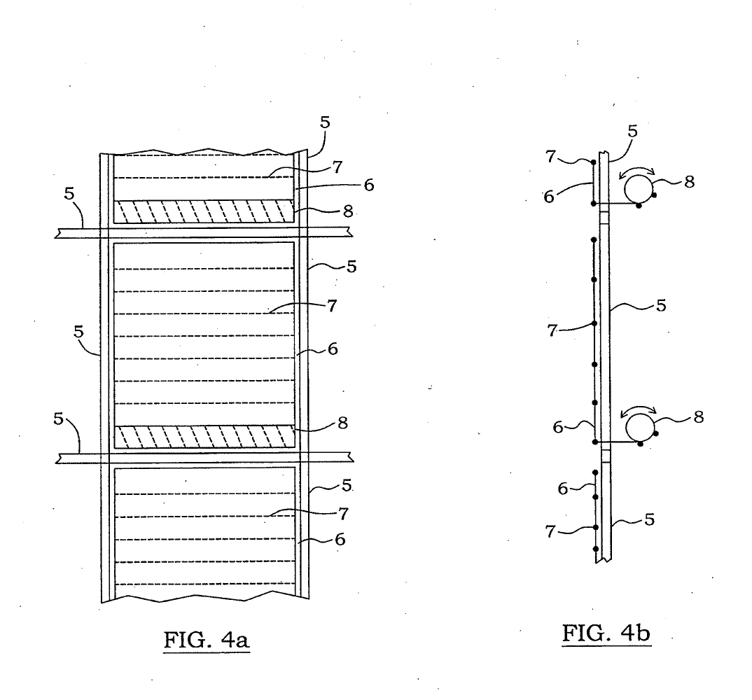

As better shown in FIGS. 4a and 4b, preferably, the apparatus further comprises at least one reinforcing bar (7) spanning each of the retractable wall panels (6) of the divergent section between adjacent divergent section structural members (5), or further comprises at least one reinforcing bar (7) spanning each of the retractable wall panels (6) of the convergent section between adjacent convergent section structural members (5). As mentioned above, if the panel (6) is retracted by winding itself around a horizontal axis (using a panel deployment and retraction mechanism (8)), the bars would be positioned horizontally in the panels. If the panels are retracted by winding themselves around a vertical axis, they would be placed vertically in the panels.

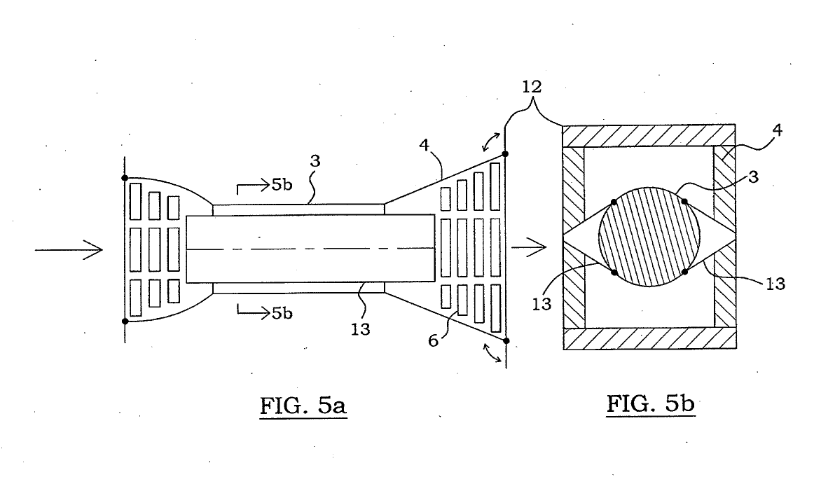

In a further preferred embodiment shown for example in FIGS. 5a and 5b, rotating or pivotable deflectors (12) are placed around the outlet of the divergent section (4) and the inlet of the convergent section (2) to form a continuous barrier. These deflectors (12) serve to increase the effective surface areas of the convergent inlet and the divergent outlet and are only deployed at low wind conditions. Their role is to assist in increasing the vacuum generated in the convergent and divergent sections of the turbine at low wind conditions. In their inactive position, the deflectors (12) are parallel to the walls of the convergent and divergent sections and, in their active position, they are at right angles to the walls. The rotating or pivoting mechanism may be hydraulic, pneumatic, geared or electrical, or any other equivalent system.

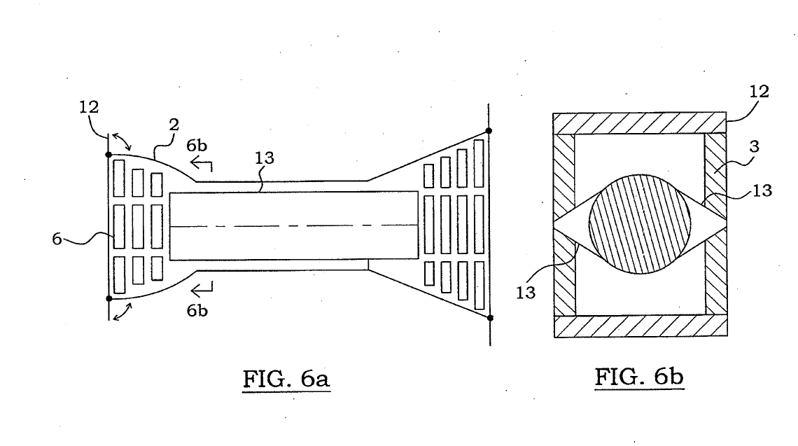

Preferably, as better shown in FIGS. 5a to 6b and mentioned above, the convergent section, the divergent section and the fluid turbine section each further comprise horizontally-mounted aerodynamic deflectors (13) to minimise wind stress and drag.

As the person skilled in the art would understand, a plurality of types of fluid turbines may be used with the device of present invention, for example, for example a single or double walled turbine. Also for each fluid turbine, different combinations may be used, for example a different number and/or configuration of blades, the space between the wall of the water turbine section and the turbine rotor. etc.

As the person skilled in the art would understand, the parameters of the convergent section and divergent sections may differ than the example shown in this document. Similarly, the fluid turbine section may differ depending of the amount of electricity to be generated.

Although preferred embodiments of the present invention have been described herein and illustrated in the accompanying drawings, it is understood that the invention is not limited to these precise embodiments and that various changes and modifications may be effected therein without departing from the scope of the present invention.

1. A fluid turbine apparatus for use with at least one fluid turbine, said fluid turbine apparatus comprising:
a convergent section, said convergent section comprising an inlet and an outlet, said inlet having a area higher than said outlet, said convergent section having a first ratio being the inlet area over the outlet area and a modular grid-like structure supporting a plurality of convergent section retractable wall panels;
a fluid turbine section adjacent to said outlet of said convergent section, said fluid turbine section comprising said at least one fluid turbine and having a central axis;
a divergent section adjacent to said fluid turbine section, said divergent section comprising an inlet and an outlet, said inlet having an area lower than said outlet, said divergent section having a second ratio being the outlet area over the inlet area and a modular grid-like structure supporting a plurality of divergent section retractable wall panels; and
a controller for selectively deploying and retracting the convergent and divergent section retractable wall panels,
wherein the fluid enters through said convergent section and exits through said divergent section.

2. The fluid turbine apparatus according to claim 1, further comprising a first continuous barrier of deflectors around a periphery of the inlet of the convergent section and a second continuous barrier of deflectors around a periphery of the outlet of the divergent section.

3. The fluid turbine apparatus according to claim 1, further comprising an operations alarm system connected to and controlled by the controller.

4. The fluid turbine apparatus according to claim 1, wherein the modular grid-like structure of the divergent section comprises structural members extending out from the central axis of the fluid turbine section and said divergent section structural members support the divergent section retractable wall panels that are deployed and retracted to adjust the second ratio and to limit wind shear stresses and generated internal vacuum.

5. The fluid turbine apparatus according to claim 1, wherein the modular grid-like structure of the divergent section comprises structural members extending out from the central axis of the fluid turbine section and said convergent section structural members support the convergent section retractable wall panels that are deployed and retracted to adjust the first ratio and to limit wind shear stresses and generated internal vacuum.

6. The fluid turbine apparatus according to claim 1, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

7. The fluid turbine apparatus according to claim 3, wherein the alarm system generates an alarm signal upon detection of an abnormality between a programmed position of the convergent section and divergent section retractable panels and an actual position of the convergent section and divergent section retractable panels.

8. The fluid turbine apparatus according to claim 2, wherein the first and second continuous barrier of deflectors are selectively deployed in low wind conditions to increase an effective area of the inlet of the convergent section and the outlet of the divergent section.

9. The fluid turbine apparatus according to claim 1, wherein the convergent section, the divergent section and the fluid turbine section each further comprise horizontally-mounted aerodynamic deflectors to minimise wind stress and drag.

10. The fluid turbine apparatus according to claim 4, further comprising at least one reinforcing bar spanning each of the retractable wall panels of the divergent section between adjacent divergent section structural members.

11. The fluid turbine apparatus according to claim 5, further comprising at least one reinforcing bar spanning each of the retractable wall panels of the convergent section between adjacent convergent section structural members.

12. The fluid turbine apparatus according to claim 2, further comprising an operations alarm system connected to and controlled by the controller.

13. The fluid turbine apparatus according to claim 3, wherein the modular grid-like structure of the divergent section comprises structural members extending out from the central axis of the fluid turbine section and said divergent section structural members support the divergent section retractable wall panels that are deployed and retracted to adjust the second ratio and to limit wind shear stresses and generated internal vacuum.

14. The fluid turbine apparatus according to claim 4, wherein the modular grid-like structure of the divergent section comprises structural members extending out from the central axis of the fluid turbine section and said convergent section structural members support the convergent section retractable wall panels that are deployed and retracted to adjust the first ratio and to limit wind shear stresses and generated internal vacuum.

15. The fluid turbine apparatus according to claim 2, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

16. The fluid turbine apparatus according to claim 3, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

17. The fluid turbine apparatus according to claim 4, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

18. The fluid turbine apparatus according to claim 5, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

19. The fluid turbine apparatus according to claim 14, wherein the controller, progressively and selectively deploys and retracts specific groupings of the convergent and divergent section retractable wall panels to control wind shear, internal vacuum and to maintain maximum power generation, based on wind speed measurements and over a wind speed range of 4.0 to 12.0 m/s.

20. The fluid turbine apparatus according to claim 19, wherein the convergent section, the divergent section and the fluid turbine section each further comprise horizontally-mounted aerodynamic deflectors to minimise wind stress and drag.
